(19) United States
(12) Patent Application Publication
(10) Pub. No.: US 2026/0339842 A1
(43) Pub. Date: Oct. 29, 2026

(54) DYNAMIC CACHE BALANCING

(71) Applicant: Dell Products L.P., Round Rock, TX (US)

(72) Inventors: Kaustubh Sahasrabudhe, Westborough, MA (US); Ramesh Doddaiah, Westborough, MA (US); Steve Ivester, Grafton, MA (US)

(73) Assignee: Dell Products L.P., Round Rock, TX (US)

(21) Appl. No.: 19/186,873

(22) Filed: Apr. 23, 2025

(51) Int. Cl. G06F 12/0802

(52) U.S. Cl. CPC G06F 12/0802; G06F 2212/60

(57) ABSTRACT

Disclosed are systems and methods for enhancing local node performance in a storage system through dynamically allocating and balancing cache segments for host operations and non-host I/O operations, including operations for replication-aware applications. Cache memory pools include a dedicated segment configured to store data and associated metadata necessary for non-host operations. The dedicated segment is dynamically sized and resized according to a time-series forecast of optimal segment sizes based on asynchronous data replication metrics.

### BACKGROUND

A distributed storage system may include a plurality of networked storage devices to provide data storage to a plurality of arrays. The plurality of storage devices and the plurality of arrays may be situated in the same physical location, or in one or more physically remote locations. The plurality of nodes and arrays may be coupled to the storage devices by a high-speed interconnect, such as a switch fabric.

Cache replacement policies or tasks include optimizing instructions or algorithms to manage a cache of information. Caching improves performance by keeping recent or often-used data items in memory locations which are faster, or computationally cheaper to access, than normal memory stores. Enterprise multi-node storage systems utilize segmented cache memory pools to optimize memory resource utilization for caching incoming host I/O data. Existing algorithms dynamically balance cache segments by adjusting memory pool sizes based on host workload patterns. While this may improve cache efficiency, such methods do not account for replication-aware features across distributed storage arrays.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one aspect, a method may include providing a memory pool defining a plurality of memory segments and defining a first memory segment in the memory pool. The first memory segment may be dedicated to storing non-host input/output (I/O) operations. One or more non-host I/O requests may be received to the first memory segment. One or more forecasts may be generated based on the received one or more non-host I/O operations. The first memory segment may be dynamically sized based on the one or more forecasts.

According to another aspect, a system may include a memory, and a processor configured to perform the operations of providing a memory pool defining a plurality of memory segments and defining a first memory segment in the memory pool. The first memory segment may be dedicated to storing non-host input/output (I/O) operations. One or more non-host I/O requests may be received to the first memory segment. One or more forecasts may be generated based on the received one or more non-host I/O operations. The first memory segment may be dynamically sized based on the one or more forecasts.

According to another aspect, a non-transitory computer-readable medium may store one or more processor-executable instructions, which when executed by a processing circuitry, further causes the processing circuitry to perform the operations of providing a memory pool defining a plurality of memory segments and defining a first memory segment in the memory pool. The first memory segment may be dedicated to storing non-host input/output (I/O) operations. One or more non-host I/O requests may be received to the first memory segment. One or more forecasts may be generated based on the received one or more non-host I/O operations. The first memory segment may be dynamically sized based on the one or more forecasts.

The methods, systems and non-transitory computer-readable media may further include, alone or in combination, one or more of the following features. The first memory segment may store remote write-pending data and associated metadata for an asynchronous replication transfer cycle. The one or more non-host I/O requests may comprise write requests. The write requests may comprise a remote data facility write-pending data. The one or more forecasts may be generated by a time-series forecasting model. The time-series forecasting model comprises an A RIM A model. The first memory segment may be sized according to a number of remote device groups configured for asynchronous replication. The one or more forecasts may be further based on one or more of a replication cycle time, a latency, a memory page consumption rate, a cycle backlog, and an external host I/O workload. The one or more forecasts may comprise one or more of a cache segment size for asynchronous replication data, a segment size for mirrored cache pools, a segment size for non-mirrored cache pools, and a duration.

### BRIEF DESCRIPTION OF THE DRAWINGS

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a block diagram of an illustrative storage system, according to aspects of the present disclosure.

FIG. 2A is a block diagram of an example storage device, according to aspects of the present disclosure.

FIG. 2B is a block diagram of a representation of logical internal communications between directors and memory of a storage system, according to aspects of the present disclosure.

FIG. 3 is a block diagram of a traditional exemplary cache balancing system.

FIG. 4 is a block diagram of a dynamic cache balancing system with an asynchronous cache segment, according to aspects of the present disclosure.

FIG. 5 is a flow diagram of a dynamic cache balancing system with an asynchronous cache segment, according to aspects of the present disclosure.

FIG. 6 is a flow diagram of a method of dynamically balancing cache, according to aspects of the present disclosure.

FIG. 7 is a block diagram of a processing device on which methods and processes disclosed herein can be implemented, according to some embodiments of the disclosure.

### DETAILED DESCRIPTION

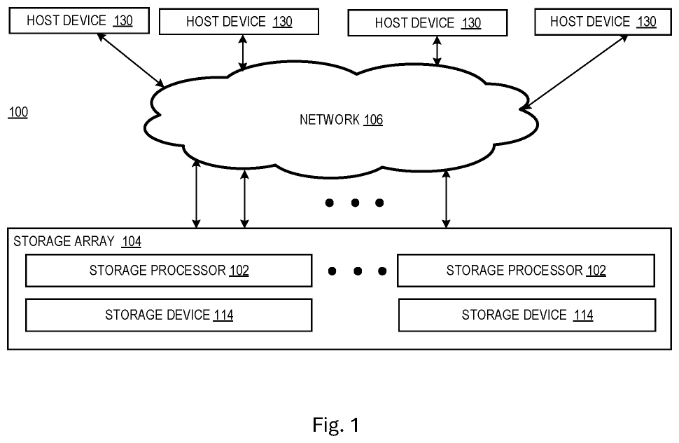

FIG. 1 is a diagram of an example of a storage system 100, according to aspects of the disclosure. As illustrated, the system 100 may include a storage array 104, a communications network 106, and a plurality of host devices 130. The communications network 106 may include one or more of a fibre channel (FC) network, the Internet, a local area network (LAN), a wide area network (WAN), and/or any other suitable type of network. The storage array 104 may include a storage system, such as DELL/EMC Powermax TM, DELL PowerStore™, and/or any other suitable type of storage system. The storage array 104 may include or be arranged with one or more node-pairs and a plurality of non-volatile memory storage devices 114. The storage devices may be configured in a RAID-1 configuration with corresponding mirrored memories. Each node of the node pairs may include one or more storage processors 102. Each of the storage processors 102 may be configured to receive Input/Output (I/O) requests from host devices 130 and execute the received I/O requests by reading and/or writing data to storage devices 114. Each of the host devices 130 may include a desktop computer, a laptop, a smartphone, an internet-of-things (IoT) device, and/or any other suitable type of computing device.

According to one aspect, each of storage devices 114 may be a non-volatile memory express (NV Me) drive. In another aspect, the storage devices may be solid-state drives (SSD). In some implementations, each of the storage devices 114 may be connected to the storage processors 102 via a Peripheral Component Interconnect Express (PCle) connection. Each of the storage devices 114 may include a respective controller (not shown) and storage medium (not shown). The controller of each storage device 114 may include processing circuitry that is configured to perform various tasks, such as the retrieval and storage of data on the medium, wear leveling, error handling, garbage collection, as well as other functions. The medium may include an array of NAND memory cells and/or any other suitable type of storage medium.

In some implementations, any of the storage devices 114 may be internal to one of the storage processors 102 and coupled to the storage processor via an M.2 slot that is provided on the motherboard of that storage processor. Additionally, or alternatively, in some implementations, any of the storage devices 114 may be part of a disk array enclosure (DAE) and coupled to each of the storage processors 102 via a respective InfiniBand adapter of that storage processor. It will be understood that the present disclosure is not limited to any specific method for connecting storage devices 114 to storage processors 102.

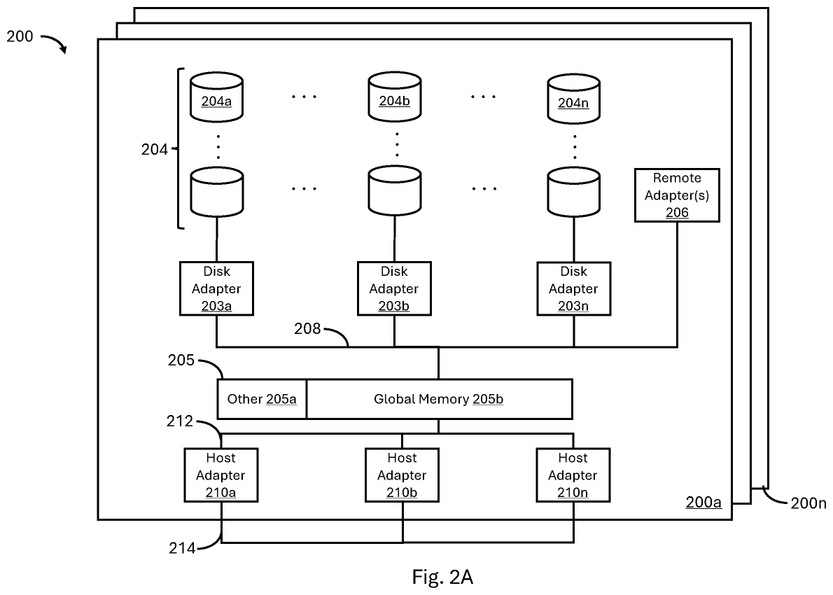

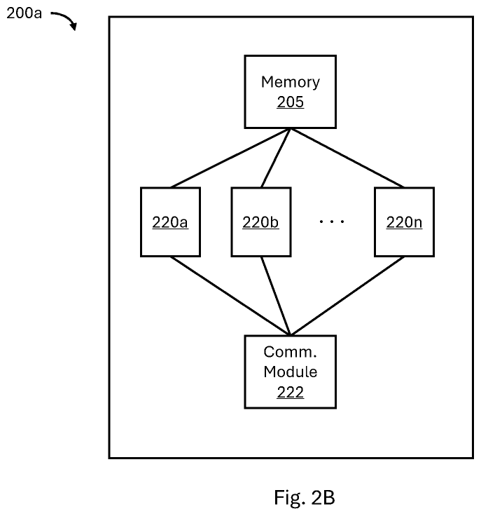

Referring to FIG. 2A, shown is an example of an embodiment of a storage array 200. Storage array 200 may be the same or substantially similar to the storage array 104 of FIG. 1. Included in the storage array 200 may be one or more arrays 200a-200n. Each of the arrays 200a-200n may be inter-connected (not shown). Additionally, the arrays 200a-200n may also be connected to host systems through any one or more communication connections 214 that may vary with each particular embodiment and device in accordance with the different protocols used in a particular embodiment. The type of communication connection used may vary with certain system parameters and requirements, such as those related to bandwidth and throughput required in accordance with a rate of I/O requests as may be issued by the host computer systems, for example, to the storage arrays 200. While this example, as described in more detail in following paragraphs, references the more detailed view of storage array 200a, it should be noted that a similar more detailed description may also apply to any one or more of the other elements, such as 200n, but have been omitted for simplicity of explanation. Each of arrays 200a-200n may be resources included in an embodiment of the system 100 of FIG. 1 to provide storage services to, for example, host computer systems. It should be noted that the storage arrays 200 may operate as stand-alones or may also be included as part of a storage area network (SAN) that includes, for example, other components.

Each of the storage arrays, such as array 200a, may include a plurality of disk devices or volumes, such as the arrangement 204 including n groupings of disks or more generally, data storage devices, 204a-204n. In this arrangement, each of the n groupings of disks may be connected to a disk adapter 203a-203n (“DA”) or director responsible for the backend management of operations to and from a portion of the disks 204. In the array 200a, a single DA, such as DA 203a, may be responsible for the management of a grouping of disks, such as grouping 204. According to one aspect, a backend DA may also be referred to as a disk controller. The DA may perform operations such as reading data from, and writing data to, the physical devices (e.g., physical storage devices also referred to as PDs) which are serviced by the DA.

Also shown in the storage array 200a is a remote adapter (RA) 206. The RA 206 may be hardware including a processor used to facilitate communication between data storage systems, such as between two of the same or different types of data storage systems.

The storage array 200a may also include one or more host adapters (“HAs”) or directors 210a-210n. Each of these HAs may be used to manage communications and data operations between one or more host systems and the global memory. In an embodiment, the HA may be a Fibre Channel Adapter (FA) or other adapter which facilitates host communication. Generally, directors may also be characterized as the different adapters, such as HAs (including FAS), DAs RAs and the like, as described herein. Components of the data storage system, such as an HA, which may communicate with a host and receive host data requests such as I/O operations may also be referred to as front end components. A component of the data storage system which communicates with a front end component may be characterized as a backend component, such as a DA. According to one aspect, various types of directors or adapters may be implemented as a processor, or, more generally, a component that includes the processor. Examples of directors are DAs, HAs, RAs, and the like, such as described herein.

One or more internal logical communication paths may exist between the DAs, the RAs, the HAs, and memory 205. An embodiment, for example, may use one or more internal buses and/or communication modules. For example, a global memory portion 205b may be used to facilitate data transfers and other communications between the DAs, HAs and RAs in a data storage system. In one embodiment, the DA s 203a-203n may perform data operations using a cache that may be included in the global memory 205b, for example, in communications with other disk adapters or directors, and other components of the storage array 200a. The other memory portion 205a may be used in connection with other designations that may vary in accordance with each embodiment.

The storage array 200a as described herein, or a particular device thereof, such as a disk, should not be construed as a limitation. Other types or configurations of data storage systems, as well as processors and hardware controlling access to these particular devices, may also be included in an embodiment.

According to one aspect of the present disclosure, host systems provide data and access control information through channels to the storage systems, and the storage arrays and storage systems may also provide data to the host systems also through the channels. The host systems may not address the disk drives of the storage systems directly, but rather access to data may be provided to one or more host systems from what the host systems view as a plurality of logical devices or logical units. A logical unit (LUN) may be characterized as a disk array or data storage system reference to an amount of disk space that has been formatted and allocated for use to one or more hosts. A logical unit may have a logical unit number that is an I/O address for the logical unit. As used herein, a LUN or LUNs may refer to the different logical units of storage which may be referenced by such logical unit numbers. The LUNs may or may not correspond to the actual or physical disk drives. For example, one or more LUNs may reside on a single physical disk drive. Data in a single storage system may be accessed by multiple hosts allowing the hosts to share the data residing therein. The HAs may be used in connection with communications between a data storage system and a host system. The RAs may be used in facilitating communications between two data storage systems. The DA s may be used in connection with facilitating communications to the associated disk drive(s) and LUN(s) residing thereon.

According to one aspect, the DA may perform I/O operations on a disk drive. Data residing on a disk drive may be accessed by the DA following a data request in connection with I/O operations that other directors originate. It should also be noted that a DA may also be a controller providing access to external physical drives or storage devices located on one or more external data storage systems rather than local physical drives located in the same physical storage system as the DA (such as illustrated in FIG. 2A) .

Referring to FIG. 2B, shown is a representation of the logical internal communications between the directors and memory included in a storage array, for example array 200a. The array 200a may include a plurality of directors 220a-220n coupled to the memory 205. Each of the directors 220a-220n may represent one of the HAs, RAs, or DAs that may be included in an array. Each of the directors may be, for example, a processor or a printed circuit board that includes a processor and other hardware components. In an embodiment disclosed herein, there may be up to sixteen directors coupled to the memory 205. Other embodiments may use a higher or lower maximum number of directors that may vary. For example, an embodiment in accordance with techniques described herein may support up to one hundred twenty-eight directors per data storage array. The representation of FIG. 2B also includes an optional communication module 222 that may provide an alternative communication path between the directors 220a-220n. Each of the directors 220a-220n may be coupled to the communication module 222 so that any one of the directors 220a-220n may send a message and/or data to any other one of the directors 220a-220n without needing to go through the memory 205.

The communication module 222 may be implemented using conventional MUX/router technology where a sending one of the directors 220a-220n provides an appropriate address to cause a message and/or data to be received by an intended receiving one of the directors 220a-220n. In addition, a sending one of the directors 220a-220n may be able to broadcast a message to all of the other directors 220a-220n at the same time.

A host may be able to access data, such as stored on a LUN of a data storage system, using one or more different paths from the host to the data storage system. A data storage system device, such as a LUN, may be accessible over multiple paths between the host and data storage system as described in more detail below. Thus, a host may select one of possibly multiple paths over which to access data of a storage device.

It should be noted that the exemplary architecture of a data storage system such as, for example, in FIGS. 2A and 2B is merely illustrative of one such architecture that may be used in connection with techniques herein. Those skilled in the art will appreciate that techniques herein may be used with any suitable data storage system. For example, FIG. 2B provides an example of components that may be included in a separate physical fabric used for control communications sent between components of the data storage system. Some embodiments may use separate physical fabrics for each of data movement and control communications between data storage system components. Alternatively, some embodiments may use a same shared physical fabric for both data movement and control communication functionality rather than having a separate control communications fabric such as illustrated in FIG. 2B.

Aspects of the present disclosure provide concepts, techniques and structures for enhancing local storage node performance through dynamically allocating and balancing cache segments for host operations and non-host I/O operations, including operations for replication-aware applications. Cache memory pools may include a dedicated segment configured to store data and associated metadata necessary for non-host operations. The dedicated segment may be dynamically sized and resized according to a time-series forecast of optimal segment sizes based on asynchronous data replication metrics.

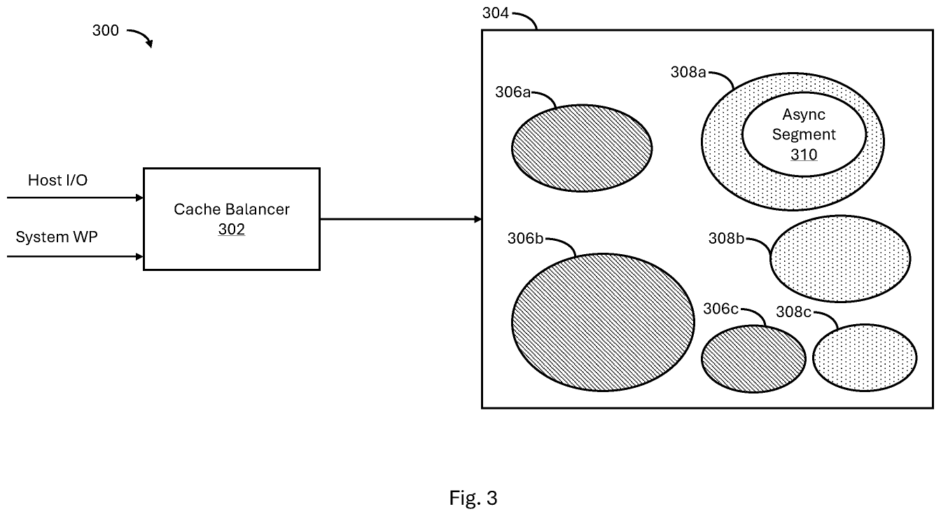

As is known in the art, multi-node arrays may include physical DRAM on each node that is pooled together and presented as logical global memory for caching read and write operations. Cache replacement policies or tasks include optimizing instructions or algorithms to manage a cache of information. FIG. 3 is a block diagram of a traditional cache balancing system 300. An enterprise storage array may be connected to at least one other array or node in an asynchronous replication topology, including for example a remote data facility (RDF) configuration, for disaster recovery or to respond to other catastrophic failures. The multi-node storage systems may utilize a global memory 304 with a segmented or fixed cache memory page layout, where memory resources are shared across internal and external applications. For example, global memory 304 may include a number of non-mirrored segments, such as segments 306a (e.g. 64 kilobytes), 306b (e.g. 128 kilobytes) and 306c (16 kilobytes), collectively referred to as non-mirrored segments 306. Global memory 304 may also include one or more mirrored memory segments, such as segments 308a (e.g. 128 kilobytes), 308b (e.g. 64 kilobytes) and 308c (16 kilobytes), collectively referred to as mirrored segments 308.

Known cache segment balancing algorithms, such as cache balancer 302 may adjust memory pool sizes based on host workload patterns (Host I/O) and system write pending (WP) operations. This may improve cache efficiency, however such methods do not account for replication-aware features across distributed storage arrays. Memory page conversion or rebalancing between nodes does not typically consider the application-level contents of each memory page before relocating data or reclaiming memory banks. Further, fixed or semi-fixed cache memory layouts may be designed based on theoretical application memory usage at the time of hardware and software configuration, limiting their flexibility to adapt in real-time to increased host or application-specific demands.

In addition to receiving I/O requests from host devices (e.g., host I/O operations), cache memory is also used for non-host I/O operations, such as asynchronous remote write-pending data in remote data facility configurations. These non-host I/O operations are managed by a fixed memory segment, such as asynchronous segment 310, and may differ from host I/O by being packed into large memory pages awaiting data transfer to another node. The asynchronous segment is a portion of an already defined pool, such as mirrored segment 308a. These remote write-pending memory pages remain “dirty” in cache for extended periods, influenced by latency and available bandwidth in asynchronous replication setups. Factors such as the number of remote device groups, static or dynamic transfer cycle time, and remote node latency contribute to the accumulation of non-data memory pages, which consume cache resources. Excessive non-data memory usage skews cache balancing accuracy, reducing its effectiveness in resizing cache pools to meet host IO demands. Other system mechanics, such as write-pending fairness, are also impacted, as mirrored memory pages are consumed by bursts of remote write-pending data, directly reducing available host-writable memory on one or more nodes.

According to one or more aspects, node performance in a storage system may be enhanced by dedicating a segment of the cache memory pool to data replication applications and their non-host I/O operations. A dedicated cache segment, referred to herein as an asynchronous replication segment, may be defined and dynamically size or resized according to one or more forecasted recommendations.

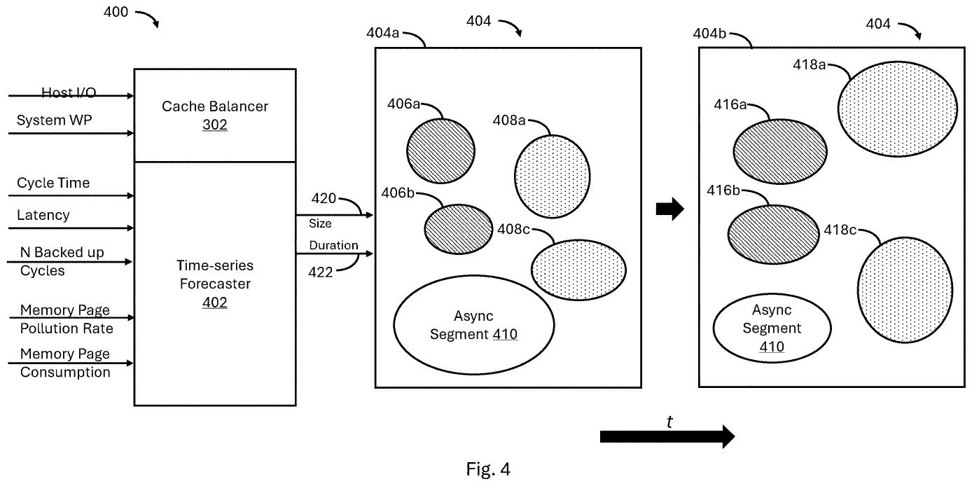

FIG. 4 is a block diagram of a dynamic cache balancing system 400 according to one or more aspects of the disclosure, showing global memory during a first time window 404a and a second time window 404b. The global memory 404 may be defined by a number of cache pools, non-mirrored, such as segments 406a, 406b and/or mirrored 408a, 408b, as well as a dedicated cache segment, such as asynchronous replication segment 410, specifically configured to manage non-host I/O operations (e.g., remote write-pending data and the associated metadata required for an asynchronous transfer cycle.). The asynchronous replication segment 410 may be initially sized based on the number of remote device groups configured for asynchronous replication.

According to one aspect, the system may include a cache balancer 302, similar to or the same as the cache balancer shown in FIG. 3 and described above. The system 400 may further include a forecaster, such as time-series forecaster 402 to generate one or more future segment sizes for the asynchronous replication segment 410. According to one aspect, the time-series forecaster may be or include an autoregressive integrated moving average (ARIMA) model. Metrics such as an asynchronous replication cycle time, latency, a number of backed up transfer cycles, memory page pollution rates, and memory page consumption across all remote device groups may be collected and analyzed. Using the time-series forecaster 402, including ARIMA forecasting, the asynchronous replication segment 410 may be dynamically scaled to optimize transfer cycles while minimizing cache memory page pollution on one or more of the nodes.

According to one aspect, as shown in the differing windows 404a, 404b, the a asynchronous replication segment 410 may be dynamically resized over time, t, based on one or more forecasts. For example, the asynchronous replication segment 410 in window 404a, may be increased in size to address an asynchronous transfer cycle latency issue. Because the asynchronous replication segment 410 is a dedicated segment within global memory 404, the performance of host I/O operations, including those managed in non-mirrored segments 406 and mirrored segments 408, is not impacted.

At a later time, however, the asynchronous replication segment 410 may be decreased in size, as shown in window 404b, for example, to support a minimum number of transfer cycles to allow for an elongated burst in host write I/O operations. The size to which the asynchronous replication segment 410 is allocated may be determined according to a recommendation 420 forecast by the time-series forecaster 402. The forecaster 402 may utilize historical data (e.g. the collected metrics) to predict when and to what extent the asynchronous replication segment 410 should be resized.

According to one aspect, the forecaster 402 may also predict or generate a recommendation for a duration of a particular asynchronous replication segment 410. Using the historical and current information, including internal and external I/O workloads, and other asynchronous replication cycle metrics discussed herein, the forecaster may generate a duration recommendation 422 for how long a asynchronous replication segment 410 may be expected or needed at a given segment size. For example, the forecaster 402 may provide a duration, t, for how long of a time period the asynchronous replication segment 410 in window 404a may be static in size. After the time, t, the system may reallocate or resize the asynchronous replication segment 410 to a recommended size as shown in the window 404b.

Accordingly, the dynamic cache balancing system 400 may improve or enhance system effectiveness of by ensuring that host-based I/O data cache segments are used exclusively for host I/O, without interference from async replication memory consumption. The asynchronous replication segment 410 may also be appropriately sized to enhance host I/O performance and reduce asynchronous replication latency at the right time, considering both internal and external array workloads. The use of the asynchronous replication segment 410 may also improve cache accuracy for host I/Os, as such balancing operations in cache balancer 302 may no longer be skewed by memory usage from internal features like asynchronous replication. Further, unnecessary CPU overhead may be reduced or elimination as the cache balancer 302 may no longer need to relocate non-host I/O operations, such as remote write-pending data and metadata memory pages during rebalancing. According to one aspect, host-based data cache segments (e.g., mirrored, 128 kilobyte) may not be artificially over-sized due to asynchronous replication demands. Instead, the asynchronous replication segment 410 may be dynamically adjusted based on actual memory page requirements.

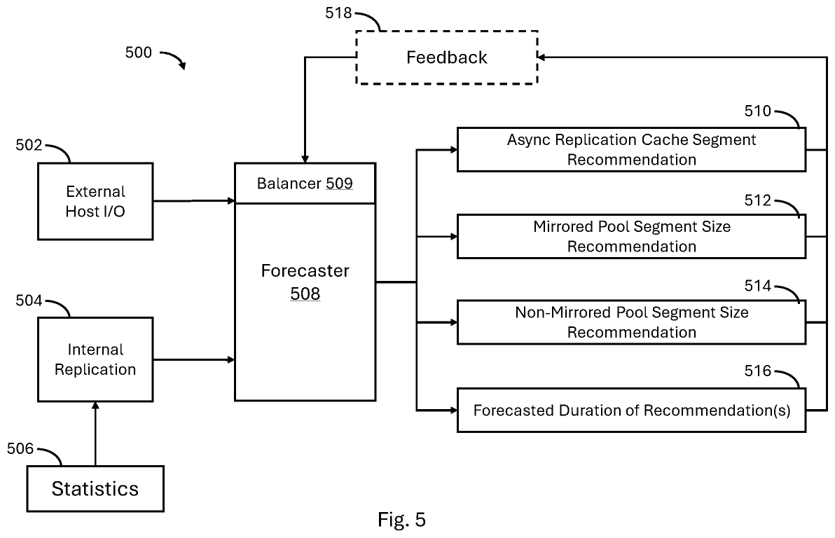

FIG. 5 is a flow diagram 500 of dynamic cache balancing forecasting with an asynchronous cache segment. According to one aspect, a forecaster 508 may be implemented to generate one or more recommendations based on inputs including external host I/O data 502 as well as internal replication (non-host I/O) data 504. The internal replication data 504 may be based on or include statistics and other data 506 related to the asynchronous data replication operations of the system. According to one or more aspects the statistics and other data 506 may include one or more of asynchronous replication cycle time, latency, a number of backed up transfer cycles, memory page pollution rates, memory page consumption, or the like.

According to aspects described herein the forecaster 508 may make one or more recommendations relating to cache segment sizes, both for host I/O operations and non-host I/O operation. The recommendations may include, but are not limited to, an asynchronous replication cache segment size 510, a mirrored pool segment size 512, a non-mirrored pool segment size 514, and/or a forecasted duration 516 for any of the recommended segment sizes. According to one aspect the recommendations may be provided as feedback 518 to balancer 509 and/or forecaster 508 for implementation of the recommendations.

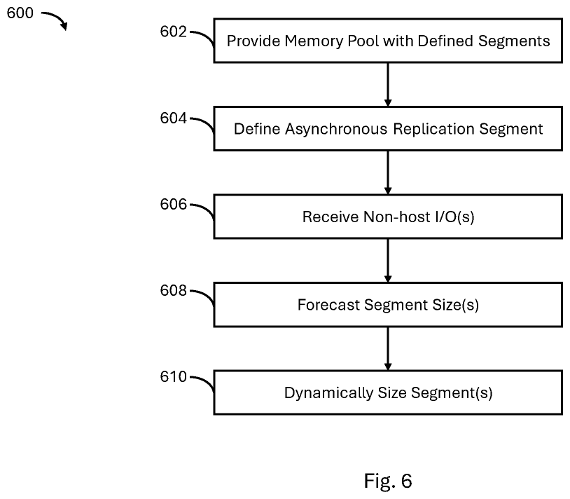

FIG. 6 is a flow diagram of a method 600 of balancing cache according to one or more aspects of the present disclosure. As described herein, a global memory pool may be defined with a number of cache segments, both for mirrored and non-mirrored applications for host I/O operations, shown in block 602. According to one aspect, shown in block 604, an asynchronous replication segment may be defined in the global memory as a dedicated cache pool configured to manage non-host I/O operations, including remote write-pending data and associated metadata for asynchronous data transfer cycles. In one aspect, an initial size of the asynchronous replication segment may be determined by the number of remote device groups configured for replication. As shown in block 606, when non-host I/Os are received that may be managed by the asynchronous replication segment, data and other metrics related to the non-host I/Os may be collected and analyzed by a time-series forecaster, such as an A RIM A forecasting model, to predict or recommend segment sizes for one or more cache segment in the global memory pool, shown in block 608. According to one aspect, a recommended duration for recommended segment size may also be generated. In one aspect, shown in block 610, the a cache balancer or other controller may dynamically size and/or resize the cache segments, including the asynchronous replication segment, according to the recommendations. In addition to the asynchronous replication segment, cache segments for non-mirrored and mirrored host I/O operations may be size and resize according to one or more recommendations.

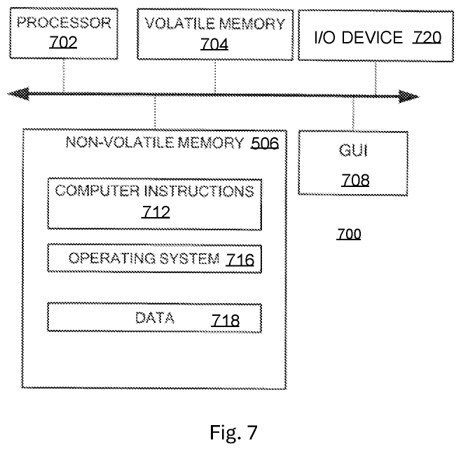

Referring to FIG. 7, in some embodiments, a computing device 700 may include processor 702, volatile memory 704 (e.g., RAM) , non-volatile memory 706 (e.g., a hard disk drive, a solid-state drive such as a flash drive, a hybrid magnetic and solid-state drive, etc.), graphical user interface (GUI) 708 (e.g., a touchscreen, a display, and so forth) and input/output (I/O) device 720 (e.g., a mouse, a keyboard, etc.). Non-volatile memory 706 stores computer instructions 712, an operating system 716 and data 718 such that, for example, the computer instructions 712 are executed by the processor 702 out of volatile memory 704. Program code may be applied to data entered using an input device of GUI 708 or received from I/O device 720.

As disclosed herein, the concepts, techniques and structures described allow for enhancing local node performance by offloading some or all cache replacement tasks to a remote node. The concepts, techniques and structures described herein provide an advantageous I/O caching system that may improve memory slot allocation by ensuring that free cache slots are always available and preventing miss I/Os from stalling due to cache subsystem overhead. Further, compute resource utilization may be optimized by reducing the load on a first array's compute resources through offloading cache-related tasks to a second array, when applicable, thus improving I/O latency on the first array. Additionally, heavily utilized compute and fabric resources on the first array's local nodes may be freed up by distributing cache work to remote boards within the first array. Further yet, a beneficial distributed workload in which the cache subsystem workload is balanced by offloading to the CPU resources of other connected arrays, utilizing remote direct memory access (RDM A) and fabric hardware for fast and efficient communication.

In some aspects or embodiments, the term “I/O request” or simply “I/O” may be used to refer to an input or output request. In some embodiments, an I/O request may refer to a data read or write request. At least some of the steps discussed with respect to FIGS. 1-5 may be performed in parallel, in a different order, or altogether omitted.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used throughout the disclosure, the term “vector” refers to a sequence of numbers (and/or other elements). The phrase “the element having index i” refers to the i-th element in the sequence.

For example, if i=1, the phrase i-th element in the sequence would refer to the first element in the sequence, if i=2, the phrase i-th element in the sequence would refer to the second element in the sequence, and so forth.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method comprising:
providing a memory pool defining a plurality of memory segments;
defining a first memory segment in the memory pool, the first memory segment dedicated to storing non-host input/output (I/O) operations;
receiving one or more non-host I/O operations to the first memory segment;
generating one or more forecasts based on the received one or more non-host I/O operations; and
dynamically sizing the first memory segment based on the one or more forecasts.

2. The method of claim 1 wherein the first memory segment stores remote write-pending data and associated metadata for an asynchronous replication transfer cycle.

3. The method of claim 1 wherein the one or more non-host I/O operations comprise write requests.

4. The method of claim 3 wherein the write request comprises a remote data facility write-pending data.

5. The method of claim 1 wherein the one or more forecasts are generated by a time-series forecasting model.

6. The method of claim 5 wherein the time-series forecasting model comprises an autoregressive integrated moving average (ARIMA) model.

7. The method of claim 1 further comprising sizing the first memory segment according to a number of remote device groups configured for asynchronous replication.

8. The method of claim 1 wherein the one or more forecasts are further based on one or more of a replication cycle time, a latency, a memory page consumption rate, a cycle backlog, and an external host I/O workload.

9. The method of claim 1 wherein the one or more forecasts comprises one or more of a cache segment size for asynchronous replication data, a segment size for mirrored cache pools, a segment size for non-mirrored cache pools, and a duration.

10. A system comprising:
a memory; and
a processor configured to perform the operations of:
providing a memory pool defining a plurality of memory segments;
defining a first memory segment in the memory pool, the first memory segment dedicated to storing non-host input/output (I/O) operations;
receiving one or more non-host I/O F s-operations to the first memory segment;
generating one or more forecasts based on the received one or more non-host I/O operations; and
dynamically sizing the first memory segment based on the one or more forecasts.

11. The system of claim 10 wherein the first memory segment stores remote write-pending data and associated metadata for an asynchronous replication transfer cycle.

12. The system of claim 10 wherein the one or more non-host I/O operations comprise write requests.

13. The system of claim 12 wherein the write request comprises a remote data facility write-pending data.

14. The system of claim 10 wherein the one or more forecasts are generated by a time-series forecasting model.

15. The system of claim 14 wherein the time-series forecasting model comprises an autoregressive integrated moving average (ARIMA) model.

16. The system of claim 10 further comprising sizing the first memory segment according to a number of remote device groups configured for asynchronous replication.

17. The system of claim 10 wherein the one or more forecasts are further based on one or more of a replication cycle time, a latency, a memory page consumption rate, a cycle backlog, and an external host I/O workload.

18. The system of claim 10 wherein the one or more forecasts comprises one or more of a cache segment size for asynchronous replication data, a segment size for mirrored cache pools, a segment size for non-mirrored cache pools, and a duration.

19. A non-transitory computer-readable medium storing one or more processor-executable instructions, which when executed by a processing circuitry, further cause the processing circuitry to perform the operations of:
providing a memory pool defining a plurality of memory segments;
defining a first memory segment in the memory pool, the first memory segment dedicated to storing non-host input/output (I/O) operations;
receiving one or more non-host I/O requests-operations to the first memory segment;
generating one or more forecasts based on the received one or more non-host I/O operations; and
dynamically sizing the first memory segment based on the one or more forecasts.

20. The non-transitory computer-readable medium of claim 19 wherein the one or more forecasts are generated by an autoregressive integrated moving average (ARIMA) time-series forecasting model.
